(19) United States
(12) Patent Application Publication
(10) Pub. No.: US 2015/0376041 A1
(43) Pub. Date: Dec. 31, 2015

(54) AQUEOUS SYSTEMS HAVING LOW LEVELS OF CALCIUM CONTAINING COMPONENTS

(71) Applicant: BAKER HUGHES INCORPORATED, Houston, TX (US)

(72) Inventors: Mary Jane Legaspi Felipe, Sugar Land, TX (US); David L. N. Fulmer, Missouri City, TX (US); Khac T. Nguyen, Houston, TX (US); Bing Bing Guo, Missouri City, TX (US)

(73) Assignee: BAKER HUGHES INCORPORATED, Houston, TX (US)

(21) Appl. No.: 14/705,735

(22) Filed: May 6, 2015

Related U.S. Application Data
(63) Continuation-in-part of application No. 14/319,668, filed on Jun. 30, 2014.

(51) Int. Cl. C02F 1/68; C01B 5/00; C23F 11/00

(52) U.S. Cl. CPC C02F 1/68; C23F 11/00; C01B 5/00; C02F 2303/22

(57) ABSTRACT

Hydroxycarboxylic acids and/or transition metal salts may be added to an aqueous system to inhibit corrosion and/or scale deposition within the aqueous system. The aqueous system may include a calcium containing component in an amount ranging from about 0.01 ppm to about 200 ppm. The hydroxycarboxylic acid may have two or more carboxylic acid groups. The transition metal salt may have or include a transition metal, such as but not limited to, Zn (II), Zn (IV), Sn, Al, Mn, Mo, and combinations thereof. The aqueous system may be or include a cooling tower, a cooling water system, and combinations thereof.

### CROSS REFERENCE TO RELATED APPLICATIONS

This application is a Continuation-in-Part application and claims priority to U.S. application Ser. No. 14/319,668 filed on Jun. 30, 2014; which is incorporated by reference herein in its entirety.

### TECHNICAL FIELD

The present invention relates to treated aqueous systems and methods for treating aqueous systems, and more specifically relates to adding hydroxycarboxylic acids or hydrocarboxylic acid salts, and transition metal salts to aqueous systems to decrease corrosion and/or scale deposition where the aqueous system includes a calcium-containing compound in an amount ranging from about 0.01 ppm to about 200 ppm.

### BACKGROUND

The problems of corrosion and attendant effects, such as pitting, have troubled water systems for years. For instance, scale tends to accumulate on internal walls of various water systems, and thereby materially lessens the operational efficiency of the system. In this manner, heat transfer functions of the particular system are severely impeded.

Corrosion is a derivative electrochemical reaction of a metal with its environment. It is the reversion of refined metals to their natural state. For example, iron ore is iron oxide. Iron oxide is refined into steel. When the steel corrodes, it may form iron oxide. Iron oxide, if unattended, may result in failure or destruction of the metal, causing the particular water system to be shut down until the necessary repairs can be made.

Water systems often have cooling water systems for cooling a water stream to a lower temperature and rejecting heat to the atmosphere. Cooling water towers may use the evaporation of water to remove process heat and cool the working fluid to near the wet-bulb air temperature, or may rely solely on air to cool the working fluid to near the dry-bulb air temperature in the case of a closed circuit dry cooling tower.

Typically, in cooling water systems, corrosion along with pitting has proven deleterious to the overall efficiency of the system. Many cooling water systems employ orthophosphate to decrease corrosion by promoting passivation of the metal surfaces in contact with the system water. However, calcium containing components are usually added to the aqueous system with a phosphorous containing compounds. The calcium containing components may deposit scale if the calcium containing components are present in large amounts.

Accordingly, the number of low or no phosphate treatment programs have been increasing with a concurrent emphasis on all or predominantly organic treatment programs that typically require relatively higher treatment dosages (i.e., >50 ppm) to be effective. Unfortunately, these high level organic treatment dosages increase the biological food in the system (carbon footprint) and increase the need for feed of toxic biocidal components to the system.

Zinc has been used to inhibit corrosion of metals, and soluble zinc salts are ingredients of many corrosion treatment programs, However, zinc salts may precipitate, particularly in cooling water. For example, when orthophosphate and zinc are both present in an aqueous system, zinc phosphate precipitation becomes a concern. Precipitation of zinc in other forms may also occur, such as zinc oxide or zinc sulfate. The retention of the respective salt constituents in ionic form, i.e. the solubility, depends upon such factors as water temperature, pH, ion concentration, and the like.

In alkaline waters, particularly above about pH 7.5, dissolved zinc tends to deposit out or drop out. Zinc salts are also known to be unstable in neutral or alkaline water and will precipitate with phosphates. Thus, if any of these conditions are present, the aqueous system becomes prone to zinc precipitation. With the formation of zinc scale, many of the surfaces in contact with the aqueous system may foul, and the amount of effective corrosion inhibitor present in the aqueous system may be significantly decreased.

Thus, it would be desirable if methods and compositions for corrosion inhibition and/or scale inhibition could be devised that can be used in the presence of low levels of calcium containing components.

### SUMMARY

There is provided, in one form, a method for adding a hydroxycarboxylic acid and a transition metal salt to an aqueous system in an effective amount to decrease at least one characteristic within the aqueous system, such as but not limited to, corrosion, scale deposition, and combinations thereof as compared to an otherwise identical aqueous system absent the hydroxycarboxylic acid(s) and the transition metal salt(s). Adding the hydroxycarboxylic acid and the transition metal salt may occur at the same time or different times. ‘Hydroxycarboxylic acid’ as defined herein includes its respective hydrocarboxylic acid salt, i.e. the mention of saccharic acid or other hydroxycarboxylic acids includes the saccharic acid salt. Such hydroxycarboxylic acid salts may be or include potassium, calcium, sodium, ammonium, and combinations thereof. ‘Corrosion’ is defined herein to include general corrosion, such as rust, as well as pitting corrosion. ‘Pitting corrosion’ is defined as a specific type of corrosion concentrated in a certain area that forms a pit or divot in the surface.

There is further provided in another non-limiting embodiment of the method where the hydroxycarboxylic acid may be or include, but is not limited to, saccharic acid, citric acid, tartaric acid, mucic acid, gluconic acid, dehydroxylated dicarboxylic acid, ketogluconic acid, ketoglutaric acid, glycolic acid, and combinations thereof. The transition metal salt may be or include a transition metal, such as but not limited to, Zn (II), Zn (IV), Sn, Al, Mn, Mo, and combinations thereof. The aqueous system may include at least one calcium containing compound in an amount ranging from about 0.01 ppm to about 200 ppm.

In another non-limiting embodiment, a treated aqueous system may include an aqueous system, at least one hydroxycarboxylic acid in an amount ranging from about 15 ppm to about 500 ppm, and at least one transition metal salt in an amount ranging from about 0.5 ppm to about 20 ppm. The treated aqueous composition may include a decreased amount of at least one characteristic selected from the group consisting of corrosion, scale deposition, and combinations thereof as compared to an otherwise identical aqueous system absent the hydroxycarboxylic acid(s) and the transition metal salt(s).

In an alternative embodiment of the treated aqueous system, the hydroxycarboxylic acid(s) may be or include, but is not limited to, saccharic acid, citric acid, tartaric acid, mucic acid, gluconic acid, dehydroxylated dicarboxylic acid, ketogluconic acid, ketoglutaric acid, glycolic acid, and combinations thereof, the transition metal salt(s) may be or include at least one transition metal, such as but not limited to Zn (II), Zn (IV), Sn, Al, Mn, and combinations thereof.

### BRIEF DESCRIPTION OF THE DRAWINGS

FIG. 1 is a graph comparing the corrosion rates between an untreated first sample and a treated second sample as applied to a metal surface;

FIG. 2 is a graph comparing the corrosion rates between an untreated first sample, a treated second sample including a phosphorous containing component, and a treated third sample without a phosphorous containing component as applied to a metal surface; and

FIG. 3 is a graph comparing the corrosion rates between an untreated first sample and a treated second sample as applied to a metal surface where both samples are in the presence of chlorides.

### DETAILED DESCRIPTION

It has been discovered that corrosion to a metal surface within an aqueous system and/or scale deposition within the aqueous system may be decreased or inhibited by adding at least one hydroxycarboxylic acid and at least one transition metal salt to the aqueous system. The aqueous system may include at least one calcium containing component in an amount ranging from about 0.01 ppm independently to about 200 ppm, alternatively from about 1 ppm independently to about 100 ppm. ‘Calcium containing component’ is defined herein to be any compound or component having a calcium atom and/or calcium ion. Non-limiting examples of the calcium containing component may be or include a calcium salt, such as but not limited to, a calcium carbonate, a calcium bicarbonate, a calcium chloride, a calcium sulfate or another calcium salt, and combinations thereof.

In a non-limiting embodiment, pitting may be decreased, which is a type of localized corrosion that leads to the creation of small holes in the metal surface. The metal surface may be or include, but is not limited to an iron-containing surface, such as steel; an aluminum-containing surface; yellow metals, such as copper and copper alloys; and combinations thereof.

The hydroxycarboxylic acid(s) and the transition metal salt(s) may suppress or reduce the amount of corrosion and/or scale deposition within the aqueous system. That is, it is not necessary for corrosion and/or scale deposition to be entirely prevented for the methods and compositions discussed herein to be considered effective, although complete prevention is a desirable goal. Success is obtained if less corrosion and/or scale deposition occurs using the hydroxycarboxylic acid and the transition metal salt than in the absence of the hydroxycarboxylic acid and the transition metal salt. Alternatively, the methods and treated aqueous systems described are considered successful if there is at least a 50% decrease in corrosion and/or scale deposition within the aqueous system.

The additive and/or the aqueous system may function properly in the presence of phosphorous-containing components, even when the calcium containing components are present in an amount less than about 200 ppm. However, in a non-limiting embodiment, the additive does not include a phosphorous-containing compound. In a non-limiting embodiment, the phosphorous containing component may include, but is not limited to, orthophosphates, polyphosphates, phosphonates, and combinations thereof. The amount of phosphorous-containing components within the aqueous system may be less than 10 ppm, or less than about 2 ppm in another non-limiting embodiment. Alternatively, the amount of phosphorous-containing components within the aqueous system may range from about 0 independently to about 0.1 ppm or independently to about 0.2 ppm. As used herein with respect to a range, “independently” means that any threshold may be used together with another threshold to give a suitable alternative range, e.g. about 0 ppm independently to about 10 ppm is also considered a suitable alternative range.

The hydroxycarboxylic acid and the transition metal salt may be added to the aqueous system at the same time as an additive, or the two components may be added at different times. The ratio of the hydroxycarboxylic acid to the transition metal salt may range from about 100:12 independently to about 15:0.5, or from about 72:8 independently to about 20:1. When added at the same time, the amount of the additive to be added to the aqueous system may range from about 16 ppm independently to about 5000 ppm, or from about 21 ppm independently to about 600 ppm.

The hydroxycarboxylic acid may have or include two or more carboxylic acid groups, alternatively from about two to about ten carboxylic acid groups, or from about three to about eight carboxylic acid groups. In a non-limiting embodiment, the hydrocarboxylic acid may be or include, but is not limited to, saccharic acid, citric acid, tartaric acid, mucic acid, dehydroxylated dicarboxylic acids, gluconic acid, ketogluconic acid, ketoglutaric acid, glycolic acid, and combinations thereof. The amount of the hydroxycarboxylic acid to be added to the aqueous system may range from about 15 ppm to about 500 ppm, alternatively from about 20 ppm independently to about 300 ppm, or from about 50 ppm independently to about 100 ppm.

The transition metal salt may have or include transition metal, such as but not limited to, Zn (II), Zn (IV), Sn, Al, Mn, Mo, and combinations thereof. The salt may be or include, but is not limited to, chlorides, sulfates, hydroxides, oxides, and combinations thereof. The amount of the transition metal salt to be added to the aqueous system may range from about 0.5 ppm to about 100 ppm, alternatively from about 6 ppm independently to about 20 ppm, or 12 ppm independently to about 18 ppm.

At least one optional additional component may be added to the aqueous system at the same time or different time as the hydroxycarboxylic acid and/or the transition metal salt. Alternatively, the additional component(s) may be present in the aqueous system prior to the addition of the hydroxycarboxylic acid and/or transition metal salt. The additional component may be or include, but is not limited to a scale inhibitor, a biocide, a taggant, a yellow metal corrosion inhibitor, and combinations thereof. The scale inhibitor may be or include, but is not limited to, polyacrylates, polymaleates, hydroxypropylacrylates, phosphonates, and combinations thereof. The polyacrylates may be or include homopolymers, copolymers, terpolymers, and combinations thereof. The scale inhibitor may be present in the aqueous system or may be added to the aqueous system in an amount ranging from about 1 ppm to about 100 ppm, alternatively from about 5 ppm independently to about 50 ppm, or from about 10 ppm independently to about 25 ppm in another non-limiting embodiment. In the alternative, the aqueous system and/or additive does not include polyacrylates or other polymer components.

The biocide may be or include, but is not limited to, sodium hypochlorite (also known as bleach), NaHCIO, chlorine dioxide, chlorine, bromine, non-oxidizing biocides, and combinations thereof. Non-limiting examples of the non-oxidizing biocides may be or include isothiazoline; glutaraldehyde; 2,2-dibromo-3-nitrilopropionamide (DBNPA); and combinations thereof. The amount of the biocide present in the aqueous system or added to the aqueous system may range from about 1 ppm independently to about 100 ppm, alternatively from about 5 ppm independently to about 50 ppm, or from about 10 ppm independently to about 25 ppm in another non-limiting embodiment.

In a non-limiting embodiment, a chemical tag may be attached to at least one of the components for purposes of tracing the component added to or present in the aqueous system, such as the hydroxycarboxylic acid, the transition metal salt, the biocide, the scale inhibitor, and combinations thereof. The chemical tag may be or include a fluorophore in a non-limiting embodiment, i.e. a chemical that emits light at a certain wavelength of light. The chemical tag may be or include a tagged polymer, p-Toluenesulfonic acid (pTSA), the scale inhibitor itself as a tag, and combinations thereof. Said differently, the scale inhibitor may act as a fluorophore when added to the aqueous system. Non-limiting examples of the scale inhibitor that may act as a fluorophore may be or include BELCLENE 200™ supplied by BWA Water Additives (a calcium carbonate scale inhibitor), Optidose™ supplied by DOW Chemical Company (a calcium phosphate scale inhibitor), and combinations thereof. The chemical tag may emit light at wavelengths ranging from about 180 independently to about 600, or from about 240 independently to about 350.

The chemical tag may be added to the system at the same time or different time from the hydroxycarboxylic acid and/or transition metal salt. The amount of the chemical tag added to the aqueous system may range from about 1 ppb independently to about 10 ppm, or from about 500 parts per billion (ppb) independently to about 6 ppm in another non-limiting embodiment. Alternatively, the amount of the ‘inherent tag’ added to the aqueous system may range from about 1 ppm independently to about 15 ppm, or from about 2 ppm independently to about 6 ppm. In another non-limiting embodiment, the amount of pTSA added to the aqueous system may range from about 1 ppb independently to about 4 ppm, or from about 100 ppb independently to about 1 ppm.

‘Aqueous system’ is defined herein to include an aqueous-based fluid and any components therein (e.g. pipes or conduits where the aqueous fluid may flow through or alongside) prior to adding the hydroxycarboxylic acid and/or transition metal salts. The aqueous-based fluid may be or include, but is not limited to, water, brine, seawater, and combinations thereof. In a non-limiting embodiment, the aqueous based fluid may circulate through a cooling tower, a cooling water system, and combinations thereof. The cooling tower may be or include an open loop cooling tower, a closed loop cooling tower, and combinations thereof. ‘Open loop’ differs from ‘closed loop’ in that the ‘open loop’ system has recirculating water therethrough. The pH of the aqueous system may be greater than about 7, alternatively from about 7 to about 9, or from about 7.3 to about 8.5 in another non-limiting embodiment.

The aqueous system may be stable in the presence of chlorine- containing components, such as chloride salts different from the transition metal salts. The chlorine-containing components may be present in the aqueous system prior to the addition of the hydroxycarboxylic acid(s) and/or transition metal salt(s). Alternatively, the chlorine-containing components may be added to the aqueous system at the same time or different time as the hydroxycarboxylic acid(s) and/or transition metal salt(s) in an amount ranging from about 1 ppm to about 1,000 ppm, alternatively from about 200 ppm independently to about 800 ppm, or an amount greater than about 500 ppm in another non-limiting embodiment.

The invention will be further described with respect to the following Examples, which are not meant to limit the invention, but rather to further illustrate the various embodiments.

### EXAMPLES

### Example 1

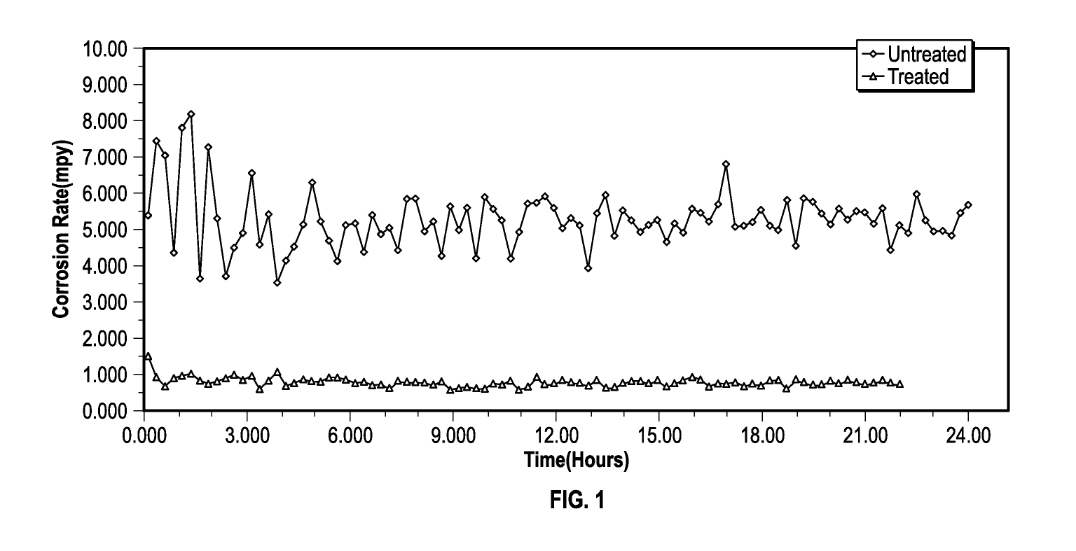

FIG. 1 is a graph comparing the corrosion rates between an untreated first sample and a treated second sample as applied to a metal surface. The water composition of both samples included 25 ppm of 0.5 ppm Fe²⁺, and zero ppm of CaCO₃, and zero ppm of any phosphorous containing components. The first sample did not include any treatment in addition to the water composition. The second sample included a treatment of a glucaric acid salt in an amount of 35 ppm, and a Zn transition metal salt in an amount of 1.5 ppm. As noted by FIG. 1, the treated second sample significantly decreased the amount of corrosion to the metal surface.

### Example 2

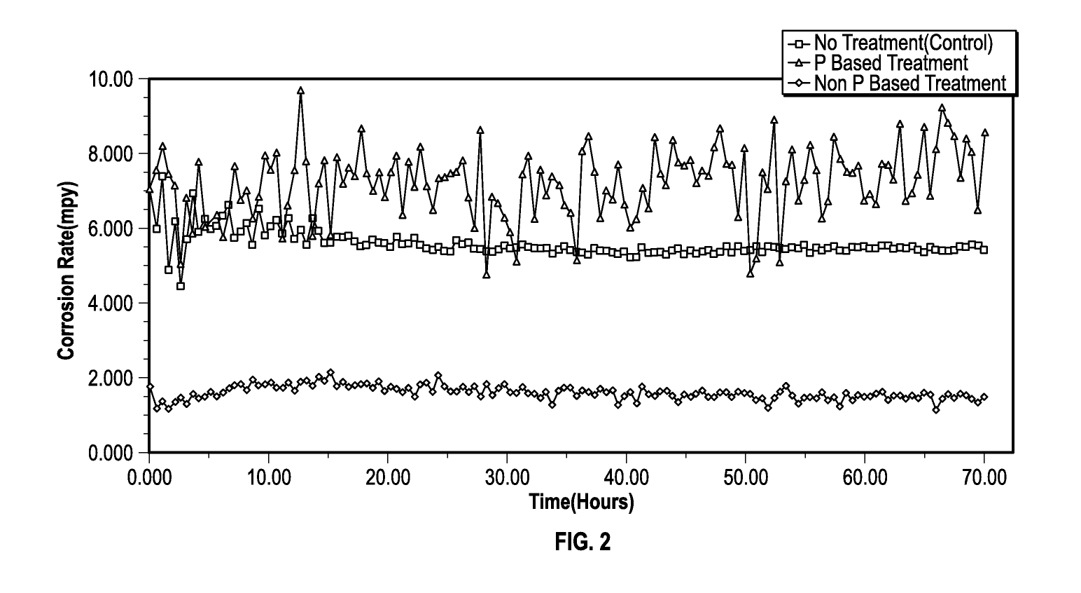

FIG. 2 is a graph comparing the corrosion rates between an untreated first sample, a treated second sample including a phosphorous containing component, and a treated third sample without a phosphorous containing component as applied to a metal surface. The water composition of all three samples included 25 ppm of 0.5 ppm Fe²⁺, and zero ppm of CaCO₃. The untreated first sample and the treated third sample had zero ppm of any phosphorous containing components. The treated second sample included phosphonocarboxylic acid in an amount of 12 ppm, 10 ppm of a polyacrylic copolymer and a Zn transition metal salt in an amount of 2.0 ppm. The treated third sample had zero ppm of any phosphorous containing components. The first sample did not include any treatment in addition to the water composition. The treated third sample included a treatment of a glucaric acid salt in an amount of 60 ppm, and a Zn transition metal salt in an amount of 2.0 ppm. As noted by FIG. 2, the treated third sample significantly decreased the amount of corrosion to the metal surface, but the treated second sample did not decrease corrosion to the metal surface in the presence of phosphorous containing components as compared to the untreated first sample.

### Example 3

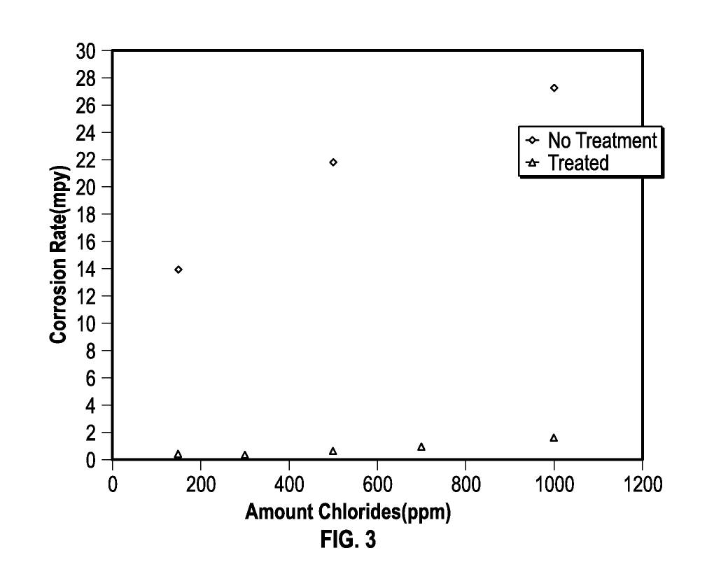

FIG. 3 is a graph comparing the corrosion rates between an untreated first sample and a treated second sample as applied to a metal surface where both samples are in the presence of chlorides. The water composition of both samples included 100 ppm (SO₄)⁻², 1.0 ppm Fe²⁺, 100 ppm of CaCO₃, and zero ppm of any phosphorous containing components. Both samples were also subjected to an increased amount of chlorides, i.e. 150 ppm to about 1000 ppm, as shown on the x-axis of the graph. The first sample did not include any treatment in addition to the water composition. The second sample included a treatment of a glucaric acid salt in an amount of 35 ppm, and a Zn transition metal salt in an amount of 2 ppm. As noted by FIG. 3, the treated second sample significantly decreased the amount of corrosion to the metal surface, even in the presence of increasing amounts of chlorides.

In the foregoing specification, the invention has been described with reference to specific embodiments thereof, and has been described as effective in providing treated aqueous systems and methods for decreasing at least one characteristic within the aqueous system having at least one calcium containing component in an amount ranging from about 0.01 ppm to about 200 ppm, such as but not limited to, corrosion, scale deposition and combinations thereof as compared to an otherwise identical aqueous system absent the hydroxycarboxylic acid(s) and the transition metal salt(s). However, it will be evident that various modifications and changes can be made thereto without departing from the broader spirit or scope of the invention as set forth in the appended claims. Accordingly, the specification is to be regarded in an illustrative rather than a restrictive sense. For example, specific aqueous fluids, calcium containing components, hydroxycarboxylic acids, transition metals, transition metal salts, phosphorous containing components, scale inhibitors, biocides, and chlorine- containing components falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, the method may consist of or consist essentially of adding a hydroxycarboxylic acid, and a transition metal salt to an aqueous system in an effective amount to decrease at least one characteristic within the aqueous system, such as but not limited to, corrosion, scale deposition, and combinations thereof as compared to an otherwise identical aqueous system absent the hydroxycarboxylic acid(s) and the transition metal salt(s) where adding the hydroxycarboxylic acid and the transition metal salt may occur at the same time or different times, and where the aqueous system comprises at least one calcium containing component in an amount ranging from about 0.01 ppm to about 200 ppm.

The treated aqueous system may consist of or consist essentially of an aqueous system having at least one calcium containing component in an amount ranging from about 0.01 ppm to about 200 ppm, at least one hydroxycarboxylic acid in an amount ranging from about 15 ppm to about 500 ppm, and at least one transition metal salt in an amount ranging from about 0.5 ppm to about 20 ppm; the treated aqueous composition may include a decreased amount of at least one characteristic selected from the group consisting of corrosion, scale deposition, and combinations thereof as compared to an otherwise identical aqueous system absent the hydroxycarboxylic acid(s) and the transition metal salt(s).

The words “comprising” and “comprises” as used throughout the claims, are to be interpreted to mean “including but not limited to” and “includes but not limited to”, respectively.

What is claimed is:

1. A method comprising:
adding at least one hydroxycarboxylic acid and at least one transition metal salt to an aqueous system in an effective amount to decrease at least one characteristic within the aqueous system selected from the group consisting of corrosion, scale deposition, and combinations thereof as compared to an otherwise identical aqueous system absent the at least one hydroxycarboxylic acid and the at least one transition metal salt; wherein the aqueous system comprises at least one calcium containing component in an amount ranging from about 0.01 ppm to about 200 ppm; wherein adding the hydroxycarboxylic acid and the transition metal salt occurs at the same time or different times.

2. The method of claim 1, wherein the calcium containing component is selected from the group consisting of calcium carbonate, calcium bicarbonate, calcium chloride, calcium sulfate, or any form of calcium salt, and combinations thereof.

3. The method of claim 1, wherein the at least one hydroxycarboxylic acid comprises two or more carboxylic acid groups.

4. The method of claim 1, wherein the at least one hydroxycarboxylic acid is selected from the group consisting of saccharic acid, citric acid, tartaric acid, mucic acid, gluconic acid, dehyroxylated dicarboxylic acids, ketogluconic acid, ketoglutaric acid, glycolic acid, and combinations thereof.

5. The method of claim 1, wherein the at least one transition metal salt comprises a transition metal selected from the group consisting of Zn (II), Zn (IV), Sn, Al, Mn, Mo, and combinations thereof.

6. The method of claim 1, wherein the effective amount of the at least one hydroxycarboxylic acid ranges from about 15 ppm to about 500 ppm.

7. The method of claim 1, wherein the effective amount of the at least one transition metal salt ranges from about 0.5 ppm to about 20 ppm.

8. The method of claim 1, wherein the aqueous system is selected from the group consisting of a cooling tower, a cooling water system, and combinations thereof.

9. The method of claim 1, wherein the aqueous system further comprises at least one component selected from the group consisting of a scale inhibitor, a biocide, a chlorine-containing component, a taggant, a yellow metal corrosion inhibitor, and combinations thereof.

10. The method of claim 9, wherein the scale inhibitor is selected from the group consisting of polyacrylates, polymaleates, hydroxypropylacrylates, phosphonates, and combinations thereof.

11. The method of claim 9, wherein the biocide is selected from the group consisting of sodium hypochlorite, chlorine dioxide, chlorine, bromine, non-oxidizing biocides, and combinations thereof.

12. The method of claim 1, wherein the aqueous system further comprises a chlorine-containing component in an amount greater than about 500 ppm.

13. A method comprising:
adding at least one hydroxycarboxylic acid and at least one transition metal salt to an aqueous system in an effective amount to decrease at least one characteristic within the aqueous system selected from the group consisting of corrosion, scale deposition, and combinations thereof as compared to an otherwise identical aqueous system absent the at least one hydroxycarboxylic acid and the at least one transition metal salt; wherein adding the at least one hydroxycarboxylic acid and the at least one transition metal salt occurs at the same time or different times; wherein the calcium containing component is selected from the group consisting of calcium carbonate, calcium bicarbonate, calcium chloride, calcium sulfate, and combinations thereof in an amount ranging from about 0.01 ppm to about 200 ppm; and wherein the at least one transition metal salt comprises a transition metal selected from the group consisting of Zn (II), Zn (IV), Sn, Al, Mn, Mo, and combinations thereof.

14. A treated aqueous system comprising:
an aqueous system comprising at least one calcium containing component in an amount ranging from about 0.01 ppm to about 200 ppm;
at least one hydroxycarboxylic acid in an amount ranging from about 15 ppm to about 500 ppm;
at least one transition metal salt in an amount ranging from about 0.5 ppm to about 20 ppm; and
wherein the treated aqueous composition comprises a decreased amount of at least one characteristic selected from the group consisting of corrosion, scale deposition, and combinations thereof as compared to an otherwise identical aqueous system absent the at least one hydroxycarboxylic acid and the at least one transition metal salt.

15. The treated aqueous system of claim 14, wherein the calcium containing component is selected from the group consisting of a calcium carbonate, a calcium bicarbonate, a calcium chloride, a calcium sulfate, or any form of calcium salt and combinations thereof.

16. The treated aqueous system of claim 14, wherein the at least one hydroxycarboxylic acid comprises two or more carboxylic acid groups.

17. The treated aqueous system of claim 14, wherein the at least one transition metal salt comprises at least one transition metal selected from the group consisting of Zn (II), Zn (IV), Sn, Al, Mn, Mo, and combinations thereof.

18. The treated aqueous system of claim 14, wherein the aqueous system is selected from the group consisting of a cooling tower, a cooling water system, and combinations thereof.

19. The treated aqueous system of claim 14 further comprising at least one chlorine-containing component in an amount greater than about 500 ppm.

20. A treated aqueous system comprising:
an aqueous system wherein the calcium containing component is selected from the group consisting of calcium carbonate, calcium bicarbonate, calcium chloride, calcium sulfate, or any form of calcium salt and combinations thereof in an amount ranging from about 0.01 ppm to about 200 ppm;
at least one hydroxycarboxylic acid in an amount ranging from about 15 ppm to about 500 ppm; wherein the at least one hydroxycarboxylic acid is selected from the group consisting of saccharic acid, citric acid, tartaric acid, mucic acid, gluconic acid, dehydroxylated dicarboxylic acids, ketogluconic acid, ketoglutaric acid, glycolic acid, and combinations thereof;
at least one transition metal salt in an amount ranging from about 0.5 ppm to about 20 ppm; wherein the at least one transition metal salt comprises at least one transition metal selected from the group consisting of Zn (II), Zn (IV), Sn, Al, Mn, Mo, and combinations thereof;
wherein the treated aqueous composition comprises a decreased amount of at least one characteristic selected from the group consisting of corrosion, scale deposition, and combinations thereof as compared to an otherwise identical aqueous system absent the at least one hydroxycarboxylic acid and the at least one transition metal salt.
